(19) United States
(12) Patent Application Publication
(10) Pub. No.: US 2002/0017447 A1
(43) Pub. Date: Feb. 14, 2002

(54) Apparatus and method for stacking flat articles on-edge in a horizontal row

(76) Inventors: Jonathan D. Emigh, Somerset, CA (US); Raymond P. Porter, Grizzley Flats, CA (US); Motaz M. Qutub, El Dorado Hills, CA (US)

Correspondence Address: R. Michael West, Boutin, Dentino, Gibson, Di Giusto, Hodell & West, Suite 300, 455 Capitol Mall, Sacramento, CA, 95814, US

(21) Appl. No.: 09/800,603

(22) Filed: Mar. 6, 2001

Related U.S. Application Data
(60) Provisional application No. 60/190,345, filed on Mar. 16, 2000.

(51) Int. Cl. B65G 37/00

(52) U.S. Cl. 198/610

(57) ABSTRACT

A high speed apparatus and method for reorienting and assembling individual ones of flat articles, such as envelopes, into horizontal rows of articles which are vertically oriented, on edge, and stacked in facing relation. Envelopes are delivered horizontally and seriatim, to an article rotation assembly. The rotation assembly reorients the envelopes into a vertical, on-edge orientation, and feeds them individually to a helical drive assembly. The drive assembly includes a pair of parallel, counter-rotating, helical screws, mounted on a pivotally suspended sub-frame. The screws transport the envelopes in spaced relation to an accumulating conveyor. The conveyor has movable brace plate, transversely positioned over a pair of conveyor belts. A roller on one end of the plate rests upon one of the belts. Successive envelopes are delivered to and stacked against the brace plate. As the pressure increases, the sub-frame pivots away from the plate until a predetermined limit is reached. A switch then actuates the conveyor belts for a brief period, to relieve the pressure. The conveyor drive cycle is thereafter periodically repeated, until a row is formed.

### CROSS REFERENCE TO RELATED APPLICATION

On Mar. 16, 2000, Applicants herein filed a provisional patent application, Ser. No. 60/190,345, disclosing the same subject matter of the present patent application. Applicants hereby claim the benefits of 35 U.S.C. 119 (e), respecting their filing of and reference to this provisional application.

### BACKGROUND OF THE INVENTION

1. Field of the Invention

The invention relates generally to devices for arranging individual flat articles into a horizontally extending row of articles, preferably so that certain of the articles, which have previously been marked to belong to a group of articles having a like characteristic, may be easily be identified and physically segregated from other articles. More specifically, the invention pertains to a high-speed accumulating conveyor for use downstream from an envelope inserter machine, for assembling and stacking a horizontal row of finished mail pieces on-edge, so they may manually be grouped into trays for mass mailing.

2. Description of the Prior Art

Certain businesses, particularly utility companies, cable television companies, and financial lending institutions, have long employed envelope inserter machines for their mass mailings to customers. The inserter machines automatically load envelopes with one or more documents, such as a customer invoice and one or more advertising flyers. After the envelopes are loaded with the documents and the flaps are sealed, they are individually transported from the inserter by means of a rapidly moving, horizontal discharge conveyor. Typically, the envelopes are then collected or accumulated in a designated area, so they may be segregated into like groups corresponding to zip codes or postal routes, for mailing.

One type of known prior art device for accumulating envelopes, either for mail processing or for subsequent handling, is termed a shingling conveyor. A shingling conveyor is typically located immediately downstream from the discharge conveyer of an inserter. The rapidly moving discharge conveyor successively flings the envelopes across the entry end of the transversely oriented shingling conveyor belt. There, the envelopes encounter an upright restraint wall. The restraint wall runs parallel to the conveyor belt, along the side of the belt opposite that from the end of the discharge conveyor. When an envelope hits the restraint wall, further longitudinal movement is arrested, and the envelope drops onto the shingling conveyor.

Because the shingling conveyor is moving relatively slowly, successive envelopes lie at a slight angle from the horizontal, overlapping each other slightly. The amount or extent of the envelope overlap is determined by the distance traveled by the shingling conveyor between the arrival of two successive envelopes. Thus, the term shingling conveyor is a consequence of the shingle-like appearance presented by a row of envelopes so arranged.

A typical shingling conveyor can accumulate approximately 50-100 finished mail pieces before it must be unloaded. At that time, an inserter machine operator visually examines the piled envelopes, looking for edge markings on the envelopes. These edge markings were previously applied to selected envelopes at an edge marking station, within the envelope inserter machine. Edge markings correspond, for example, to the beginning or the end of a zip code, or a postal route break. Thus, all of envelopes between two of the edge marked envelopes have the same zip code. The machine operator then lifts one group of like envelopes from adjacent groups of envelopes, and places that segregated group into an appropriate mail container or tray.

One problem with prior art shingling conveyors is capacity. Modem envelope inserters, or “stuffing” machines, may load as many as 25,000 to 30,000 pieces of mail per hour. With their limited capacity, shingling conveyors require frequent unloading operations, and are therefore labor intensive. If a single inserter machine operator is running a number of inserters, the overall speed of the inserters must be slowed down, so that the operator can keep up with the unloading operations. Alternatively, more operators must be hired to maintain the high speed operation which the modern inserters can provide.

Another problem with shingling conveyers is the required gathering up of the shingled envelopes so their side edges are vertically oriented. This operation is somewhat awkward, and may result in misaligned envelopes or a dropped stack of envelopes.

Yet another problem with shingling conveyers is their inability to provide sufficient compressive forces on the envelope flaps, to form a better seal. Since the envelope flaps have just been sealed upstream from the shingling conveyer, the flap adhesive is still not fully cured while the envelopes are being handled, and flap separation or a poor seal may result.

### SUMMARY OF THE INVENTION

The present invention provides a high speed apparatus and an associated method, for reorienting and stacking in a horizontal row, any type of relatively thin, flat article, such as an envelope. Typically, the present apparatus is used in conjunction with an upstream envelope inserter. The envelope inserter deposits one or more documents into an envelope, and then seals the envelope flap. The finished mail pieces are outputted from the inserter seriatim, lying flat on a horizontally oriented discharge conveyor.

A first component of the apparatus is an article rotation assembly. This assembly reorients the envelopes from their incoming horizontal orientation to a vertical, on-edge orientation, as the envelopes are moved in a first direction. The rotation assembly includes a pair of wide, flat endless belts, which undergo a 90 degree twist between a horizontal input end to a vertical output end. As the envelopes are sandwiched between the belts moving from the input end to the output end, they undergo the same change in planar orientation as the belts do.

Depending upon the handedness of the twist which the belts undergo, the front face of the envelope may either be reversed or maintained as forward facing, when the envelope is reoriented. The handedness is changed by simply removing the input end of the belts from their supporting input rollers and twisting the belts in the opposite direction before reinstalling them on the rollers. This capability makes the present rotation assembly very versatile for the user, as the assembly can process envelopes discharged from the inserter which are either down facing or up facing.

The distance between the input rollers is preset at approximately ¼41 , so that articles which are relatively thick, or which are slightly misdirected from the horizontal plane, will easily be accommodated.

Spring-biased tensioning rollers are positioned both at the input end and at the output end of each belt, to urge adjacent portions of the two belts together. In this way, both thick and thin envelopes will be positively gripped by the belts, without the necessity of any further adjustment or other accommodation.

Optical sensors are located at the input and output ends of the rotation assembly, as well. The outputs of the sensors are fed to a computerized controller which times the progress of each envelope as it passes through the article rotation assembly. Checks on article progress are made regarding the assembly input, output, and overall throughput, so that jams or other operational anomalies will quickly be detected and remedied by the operator.

A second component of the apparatus is a helical drive assembly, positioned transversely with respect to the envelopes outputted from the rotation assembly. The helical drive assembly includes a pair of parallel, counter-rotating, helical screws, having an entry end and an exit end. The helical screws are horizontally oriented, and mounted in vertically stacked relation on a sub-frame. The lower end of the sub-frame is pivotally mounted on a main frame, allowing the sub-frame to rotate about a horizontal axis through a limited range of forward/rearward travel. At the entry end, the helical screws receive individual envelopes from the rotation assembly. The screws then transport the envelopes in parallel spaced relation, in a second direction, preferably offset 90 degrees in orientation, from the first direction.

The envelopes are thereby transported to a third component of the present apparatus, an accumulating conveyor. The accumulating conveyor preferably includes a pair of parallel conveyor belts on an article stacking table. The conveyor belts have a common longitudinal axis between them which is coincident with the output axis of the helical screws. The conveyor belts also have a feed end, adjacent the exit end of the helical drive assembly. In addition, the conveyor belts are driven in tandem, by a single electric motor, so that envelopes stacked thereon are moved evenly, and in parallel relation.

The accumulating conveyor also includes a vertically oriented article brace plate. The brace plate is transversely positioned with respect to the conveyor belts, so as to provide a movable backing against which successive envelopes may be arranged on-edge, in horizontally stacked relation. The brace plate is mounted on a special drive and suspension system which allows the plate to move forwardly with the belt, as the envelopes are successively delivered by the helical drive assembly and compressively stacked together on the article table. The drive and suspension system also allows the brace plate to be moved rearwardly, back over the belt, after a stack has been removed and the conveyor is cleared to form a new stack.

One end of the brace plate includes a bearing which slides over a horizontal support rod. The support rod is mounted adjacent and parallel to a first one of the conveyor belts. The support rod extends substantially the same length as both conveyor belts. Because the brace plate is maintained in sliding relation with the support rod, the brace may be driven to or manually positioned at, any desired location along the belts.

The other end of the brace plate includes a support wheel, which rests upon the second one of the conveyor belts. The support wheel maintains the lower edge of the brace plate in vertically spaced relation from the upper surfaces of the conveyor belts. The support wheel has a one-way clutch mechanism which locks the wheel against forward, rolling motion. Surface friction between the support wheel and the second conveyor belt thereby effects advancement of the brace in concert with forward movement with the belt.

A spring-biased return assembly is mounted adjacent the feed end of the conveyor belts. The return assembly includes a retractable cable having an extensible end which is attached to the one end of the brace plate. The return assembly is effective automatically to retract the brace plate rearwardly, back to the feed end location, after a stacked row of envelopes is removed from the apparatus.

Successive envelopes are delivered to and stacked against the brace plate by the helical drive assembly. As the compressive pressure increases in the developing envelope stack, the sub-frame supporting the helical drive assembly pivots rearwardly, away from the support plate, until a predetermined physical limit is reached. A proximity switch then actuates the electric motor to advance the conveyors, the brace plate, and the formed stack of envelopes forwardly. This action also allows the sub-frame to rotate forwardly, and temporarily relieves the pressure in the envelope stack. As the proximity switch no longer detects the presence of the sub-frame, the conveyor motor is deactivated.

When the pressure builds again as more envelopes are added to the stack, the forward drive cycle for the conveyors is repeated. This intermittent drive cycle is repeated until a plurality of envelopes is assembled on-edge, into stacked, facing relation, to form a horizontal row. The envelopes are tightly stacked and vertical, ready for immediate transfer to mail trays or mailing containers.

After a full stack of envelopes has been formed on the conveyor, the operator removes the horizontally stacked envelopes from the accumulating conveyor. The one-way clutch mechanism permits rearward rolling movement of the support wheel, and the rearward pulling forces provided by the return assembly bring the brace plate back to the feed end of the conveyor. The apparatus then begins the formation of a new stack of envelopes through continued delivery of envelopes to the article brace plate.

It is an object, therefore, of the present disclosure to provide an apparatus which reorients incoming horizontally oriented envelopes into a vertical, on-edge orientation.

It is a further object to provide an apparatus which arranges a plurality of envelopes on-edge, in facing relation, so as to form a tightly stacked, horizontal row of envelopes.

It is also an object of the present invention to provide a high speed accumulating conveyor having a improved capacity so as to allow an upstream inserter to run at fall speed.

Another object of the invention is to provide an apparatus and a method which reorient incoming articles, either face up or face down, in the desired direction, before arranging them on-edge and stacked, in a horizontal row.

Yet another object of the invention is to provide a means for arranging envelopes tightly stacked in a horizontal row, so that previously made edge markings on the envelopes will be clearly visible.

The preceding objects, as well as others will become apparent, in the drawings and the written description of the invention to follow.

### BRIEF DESCRIPTION OF THE DRAWINGS

FIG. 1 is a left front perspective view of the apparatus of the present invention;

FIG. 2 is a view as in FIG. 1, further showing the discharge conveyor of an inserter, and a horizontal row of on-edge stacked envelopes;

FIG. 3 is a top plan view of the article rotation assembly with the top cover removed to show the two belts, the input and output pulleys, and the spring-loaded tensioning rollers;

FIG. 4 is a side elevational view of the article rotation assembly with the side cover removed;

FIG. 5 is a fragmentary, side elevational view of the helical drive assembly and its sub-frame, showing three envelopes in transport;

FIG. 5A is a detail view, taken to an expanded scale, showing the proximity switch and the adjustable spring tensioner for the sub-frame;

FIG. 6 is a fragmentary, end elevational view of the helical drive assembly, showing the sub-frame and a single envelope in the helical screws, a portion of the belt and pulley drive being removed for clarity;

FIG. 7 is a fragmentary, top plan view of the helical drive assembly and the accumulating conveyor;

FIG. 8 is a fragmentary, side elevational view of the accumulating conveyor, showing the support rod and the spring-biased plate retracting mechanism for the brace plate;

FIG. 9 is a schematic representation of the key components of the apparatus of the present invention; and, FIG. 9A shows the article rotation assembly of FIG. 9, but with the belts in an alternative position, so as to face the articles in a direction on the accumulating conveyor opposite to that effected by the belt position shown in FIG. 9.

### DETAILED DESCRIPTION OF THE PREFERRED EMBODIMENT

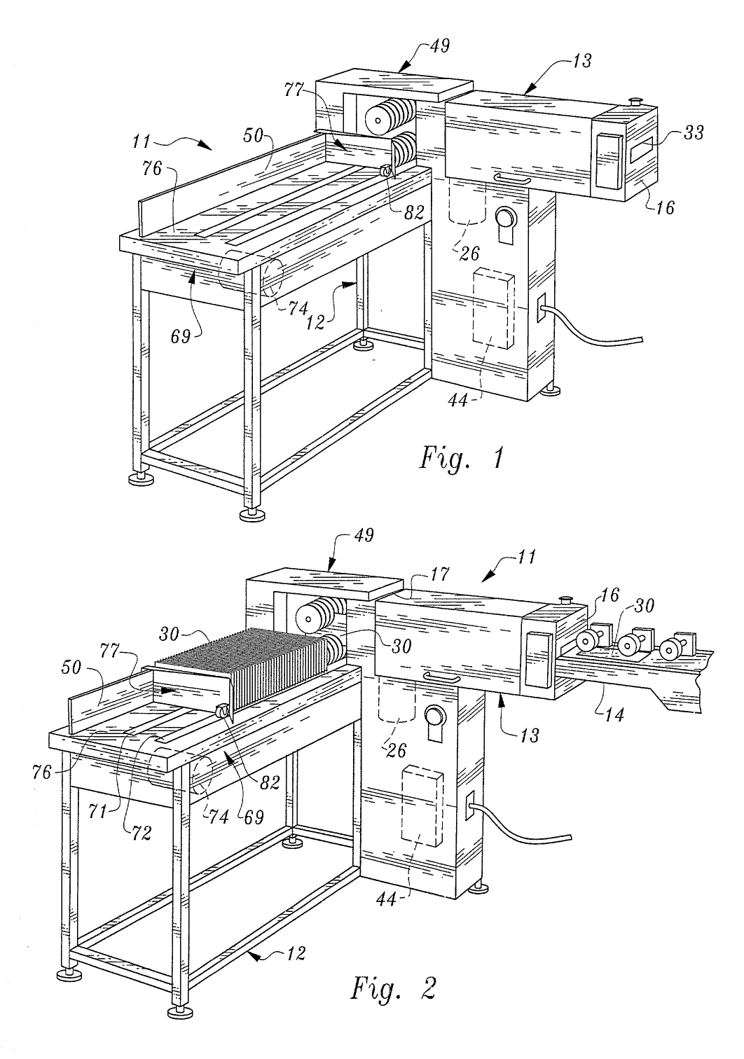

Turning now to the drawings, FIG. 1 shows the apparatus 11 for stacking flat articles on-edge in a horizontal row. The apparatus 11 includes an L-shaped main frame 12, upon which the major components of the device are mounted. An article rotation assembly 13 is secured to one end of the frame, at an elevation which matches a discharge conveyor 14 of an upstream envelope inserter (not shown).

The article rotation assembly 13 has an input end 16 and an output end 17. A first, flat endless belt 18 and a second, flat endless belt 19 are supported at the input end by first and second, horizontal input rollers 21. And, belts 18 and 19 are supported at the output end of assembly 13, by first and second, vertical output rollers 22. Rollers 21 and 22 are rotatably supported by bearings 23, with respective drive shafts 24 being belt driven by electric motor 26. Rollers 21, in turn, rotate about respective idler shafts 27.

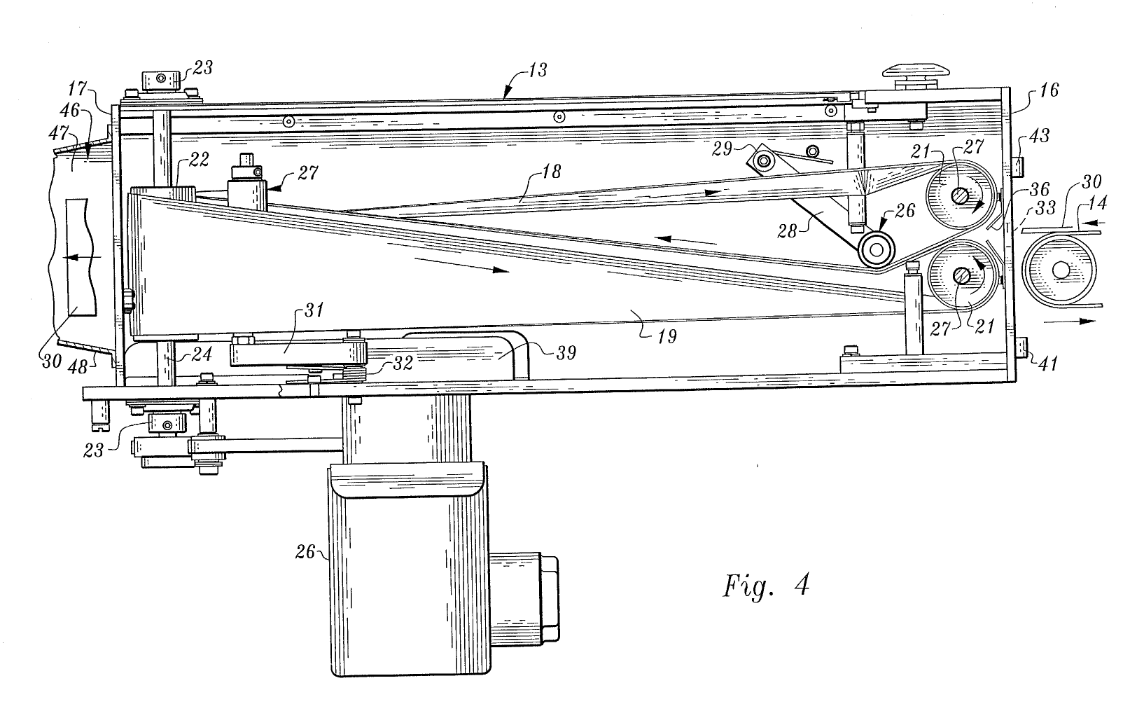

The first and second rollers 21 have axes which are parallel with respect to each other and parallel to a plane of an article 30, incoming from a horizontal discharge conveyor 14. Article 30 may be any item which is generally planar in nature, such as an envelope. As will be most apparent in FIG. 4, the first input roller 21 is above the article plane and the second input roller 21 is below the article plane. Rollers 21 are spaced so that adjacent surfaces are approximately ¼″ from each other. This provides a relatively large article acceptance gap, so that articles of varying thicknesses can be accommodated without having to adjust the spacing of the input rollers.

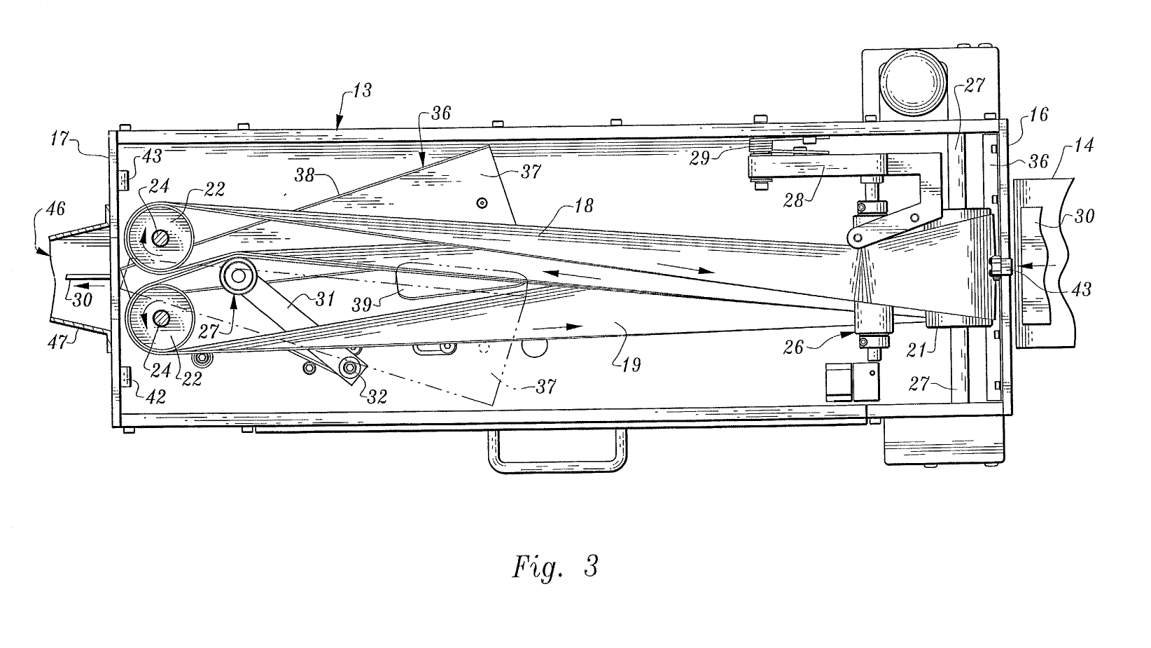

Rotation assembly 13 also includes upstream tensioning roller 26 and downstream tensioning roller 27. Upstream roller 26 includes an arm 28 and a spring 29, and downstream roller similarly includes an arm 31 and a spring 32. As shown in FIG. 4, upstream roller 26 is spring biased and in rolling engagement with inner runs of belts 18 and 19. And, making particular reference to FIG. 3, downstream roller 27 is also spring biased and in rolling engagement with inner runs of belts 18 and 19. In this manner, tensioning rollers 26 and 27 act to keep the inner runs of the belts in contingent relation at all times, so they will firmly grip incoming articles irrespective of their thickness.

An article 30, upon first entering the input end of the assembly 13, passes through a rectangular aperture 33. Angled input guides 34 are provided to redirect the incoming article, if necessary, toward the gap between the first and second input rollers 21. Therein, the article is firmly grasped by the converging inner runs of belts 18 and 19. Owing to the counter rotating drive forces applied to the belts 18 and 19, the inner, proximate runs of the belts travel from the input end to the output end. The outer, remote runs of the belts make the return trip, from the output end to the input end. In that manner, articles are transported in a first direction, from the input end to the output end of the assembly 13. Because the belts 18 and 19 go through a 90 degree twist, in progressing from a horizontal orientation at the input end to a vertical orientation at the output end, the articles are reoriented in likewise fashion, when they are transported through the assembly by the belts.

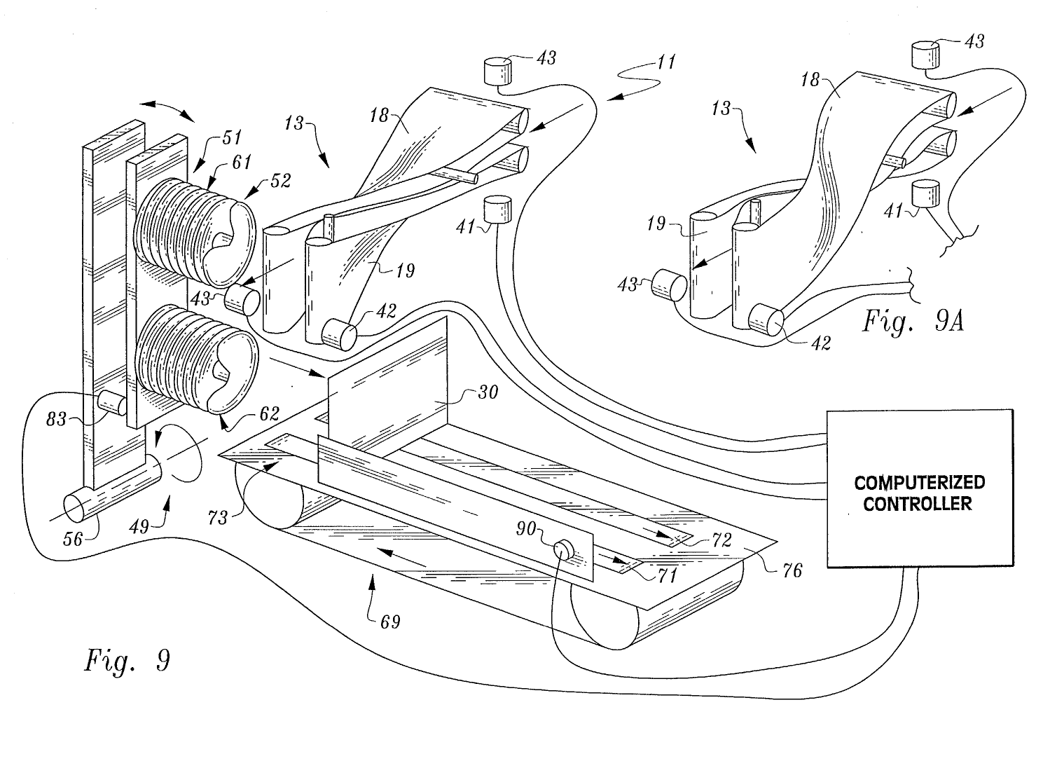

An article deflection plate 36 is posited in the floor of assembly 13, beneath belts 18 and 19. A downstream end of plate 36 is pivotally attached to the assembly, so that the plate can be rotated through a horizontal plane from a first position shown in full line, to a second position shown in broken line. ( See, FIG. 3). The first position is proper for the arrangement of the belts 18 and 19, as they are shown in FIGS. 3 and 9. The second position is proper for the arrangement of the plate as the belts are shown in FIG. 9A. In other words, plate 36 must be repositioned depending upon the arrangement of the belts, and upon the consequent direction and manner in which the articles are to be reoriented.

Plate 36 has a middle portion 37 which is flat, and has lateral portions 38 and 39 which are angled upwardly. The upstream end of plate 36 is approximately half-way between the input and output ends. By the time articles reach this half-way point, they have been rotated about 45 degrees. Deflection plate 36 provides assurance that if an article has slipped downwardly, away from the grasp of the belts, the article will slide along the plate 36, and continue its progress toward the output end of assembly 13. Plate 36 thereby reduces the chances that a mishandled or defective article will jam the rotation assembly. The deflection plate also assures that the bottom edges of all articles will properly be aligned upon their exit from the assembly.

Assembly 13 also includes an optical input sensor 41 and an optical output sensor 42, and respective light sources 43. Sensors 41 and 42 have outputs fed to a computerized controller 44. When an article 30 enters assembly 13, sensor 41 detects the leading edge of the article and sends an output signal to controller 44. Controller 44 includes hardware and software which make a timeout analysis of the duration of the output signal from sensor 41. An average article takes approximately 0.10 second to clear the input end of the assembly 13. The timeout analysis is programmed so that if the input end is not cleared after 0.50 second has passed, a fault condition will be triggered. In this event, the apparatus 11 is either automatically stopped, or the operator is notified of the fault condition, by a visual or an aural signal. A typical fault condition at the input end would involve an article jam, caused by a misaligned article or an article which has been sealed improperly.

Similarly, sensor 42 provides information to the controller 44, regarding the output of the article from the assembly 3. The same timeout analysis is performed, so if the article is jammed at the output end, and the 0.50 second time limit is exceeded, a fault condition will again be triggered.

A third type of fault condition analysis is performed by the controller 44, in which the controller checks for overall article throughput. Each time an incoming article is detected by sensor 41, the controller 44 counts up an article counter. Each time an outgoing article is detected by sensor 42, the controller counts down the article counter. If the article counter exceeds three counts, then a fault condition will be triggered. This circumstance would arise if incoming articles became jammed or lost, between the input and the output ends of the assembly 13.

An article funnel 46 is provided at the output end 17 of the assembly 13. The funnel 46 has converging sidewalls 47, and an upwardly inclined floor 48. Funnel 48 is effective to direct the article outputted from article rotation assembly 13 into a helical drive assembly 49. The leading edge of each incoming article first comes into contact with an upstanding article barrier wall 50. Wall 50 not only arrests further longitudinal movement of the articles, but also, it serves as an alignment guide and a restraint for the edges of the articles, as the article stack is subsequently formed.

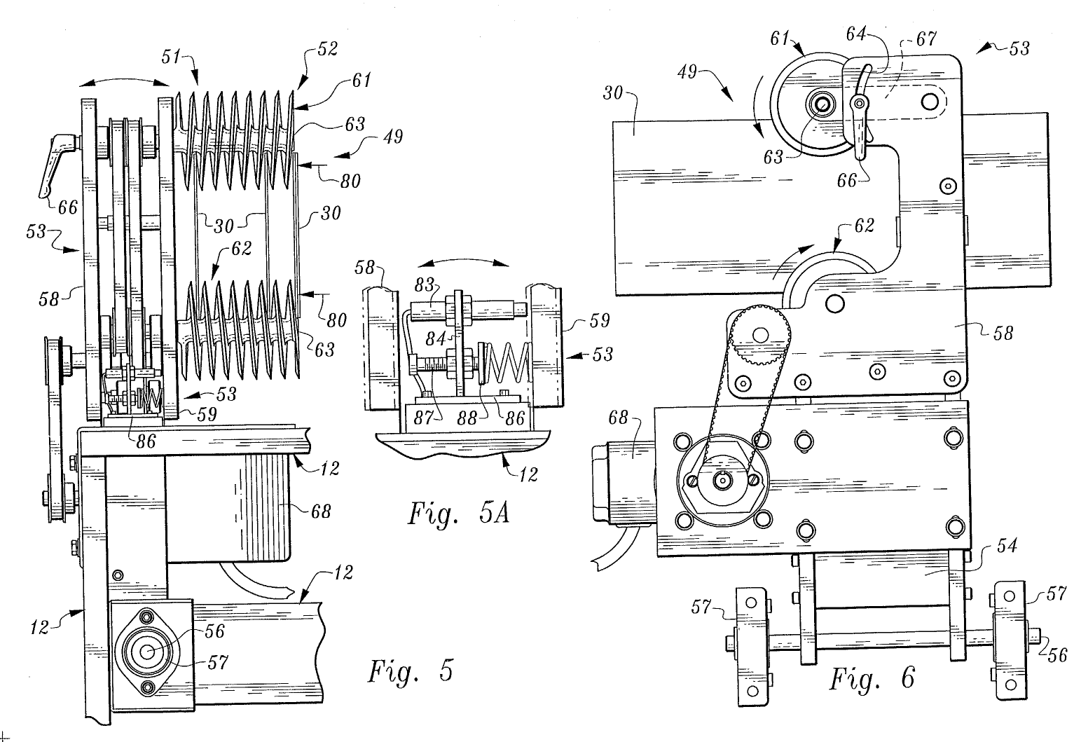

Helical drive assembly 49 has an entry end 51 and an exit end 52. Drive assembly 49 includes a sub-frame 53, pivotally mounted at its lower end 54 to main frame 12. This pivotal arrangement is effected by an axle 56 secured for rotation within bearings 57. (See, FIGS. 5 and 6).

Sub-frame 53 includes a rear plate 58 and a forward plate 59, maintained in parallel relation. An upper helical screw 61 and a lower helical screw 62 are mounted for rotation within plates 58 and 59, with their axes substantially horizontal, and parallel with respect to each other. As can be seen most clearly in FIG. 5, screws 61 and 62 are arranged in vertically spaced relation, with the distance between opposing surfaces of their respective axles 63 being slightly greater than the height of the article 30. This distance is readily adjustable to accommodate articles of different heights, by means of an arcuate slot 64 and a locking handle 66. By rotating axle arm 67 through the arc of travel of slot 64, different vertical positions for the axle 63 of upper helical screw 61 may be established.

Helical screws 61 and 62 are of opposite handedness or thread direction. The grooves in the screws are of sufficient depth so as to control and manipulate a significant portion of the upper and lower edges of the articles 30. It is preferable that screws 61 and 62 are manufactured from a plastic material, such as TEFLON, or the like, so as to minimize friction between the article and bearing surfaces of the screws. An electric motor 68 provides rotating drive forces to the screws 61 and 62, through a number of pulleys and belts which will not be discussed in further detail herein. It is apparent that separate direct drive motors could be substituted for the single drive motor. Moreover, different gear or belt arrangements could be employed in lieu of the mechanisms shown in the drawings.

It should be noted that the screws are rotatably driven in opposite directions. When viewed as shown in FIG. 6, the upper screw 61 is driven in counter-clockwise fashion, and the lower screw 62 is driven in clockwise fashion. This arrangement results in a smooth, on-edge translation of the articles 30. The counter-rotating forces provided by the upper and lower helical screws also urge the articles against the barrier wall 50, so as to move and to maintain the articles in aligned, parallel spaced relation as they are transported from the entry end 51 to the exit end 52. It should be noted that when articles outputted from the assembly 13 initially encounter the barrier wall 50, they may bounce back from the wall, in erratic and unpredictable fashion. The aligning feature provided by the helical screws quickly urges all such errant articles against the barrier wall into common edge alignment. It should be evident that this aligning feature is important in the subsequent formation of the horizontally stacked row of articles.

At the exit end 52 of the helical drive assembly 49, the articles are delivered to accumulating conveyor 69, comprising a third major assembly of the apparatus 11. Accumulating conveyor 69 includes a first conveyor belt 71, a second conveyor belt 72, and a feed end 73 Although it is preferable to use a pair of parallel conveyor belts, as they inherently provide balanced drive and support for articles, it is evident that a single wide belt would also work well in this application. Belts 71 and 72 are driven in tandem by a conveyor motor 74, which lies beneath an article stacking table 74.

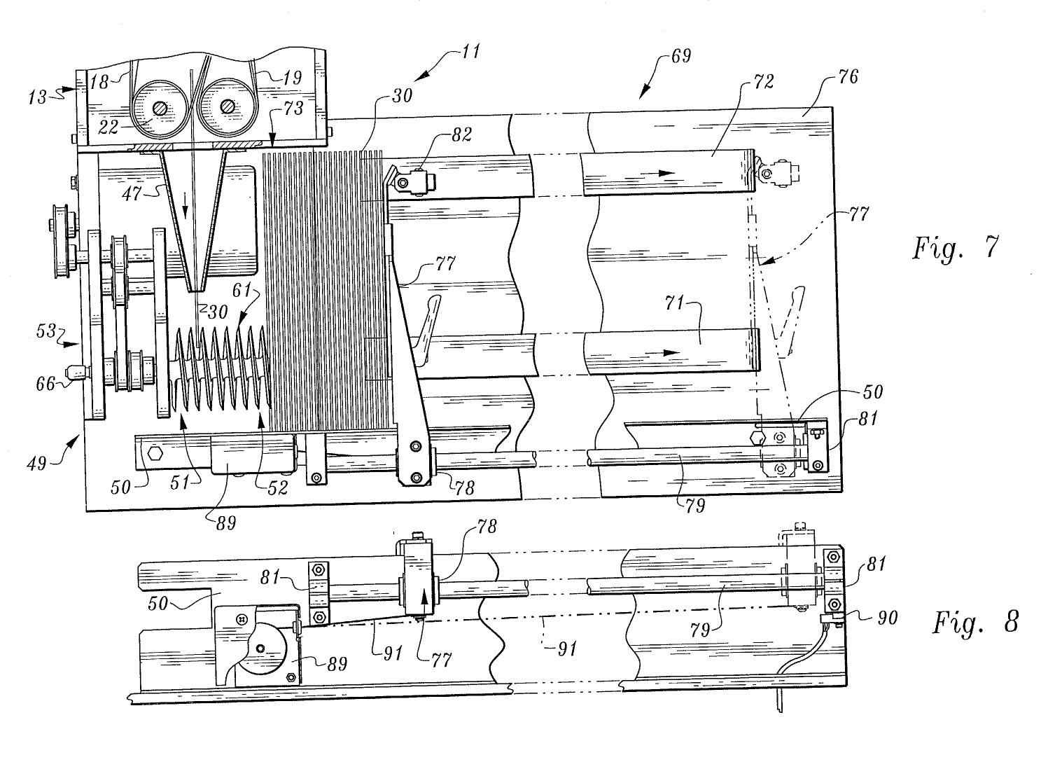

The accumulating conveyor 69 also includes a vertically oriented, article brace plate 77. The laterally supportive forces provided by brace plate 77 are represented by force arrows 80, shown in FIG. 5. Making reference now to FIG. 7, the brace plate 77 is transversely positioned with respect to the conveyor belts 71 and 72. The brace plate has a unique drive and suspension system which allows the plate to move forwardly with the belt, as the envelopes are compressively stacked together on the article table 76. The suspension system also allows the brace plate to be moved rearwardly, back over the belt, after a formed stack has been removed and the conveyor is readied to form a new stack.

One end of the brace plate 77 includes a bearing 78. The bore of bearing 78 slides over a horizontal support rod 79, maintaining article brace plate 77 in perpendicular relation to rod 78. Rod 79 is secured at either end by brackets 81, which in turn are attached to barrier wall 50. Support rod 79 is parallel to the first and second conveyor belts 71 and 72, and extends generally the same length as the belts, over table 76.

A support wheel 82 is mounted beneath the other end of the brace plate 77. Support wheel 82 rests upon second conveyor belt 72, and maintains the lower edge of the brace plate in vertically spaced relation from the upper surfaces of the conveyor belts. The support wheel has a one-way clutch mechanism which prevents the wheel from rolling forwardly. Thus, any forward movement of belt 72 effects advancement of the brace plate 77 to the same extent.

The helical drive assembly 49 successively delivers articles 30 against the brace plate 77. This results in the articles being arranged on-edge, and in horizontally stacked, face-to-face relation. As more article are stacked against the brace, the compressive forces increase. These forces eventually cause the sub-frame 53, supporting the helical drive assembly, to pivot rearwardly, away from the support plate 77, until a predetermined extent of rotation is reached.

The apparatus 11 includes a sensing mechanism to determine the extent of rotation of sub-frame 53. Making particular reference to FIG. 5A, a proximity sensor or switch 83 is provided. Proximity switch 83 maybe a Hall-effect sensor, or any other suitable capacitive, inductive, optical, or magnetic sensor or switch. Proximity switch 83 is mounted to a vertical plate 84 which extends from a base 86. Base 86 is secured to frame 12. Also mounted to plate 84 is a threadably adjustable screw 87. A spring 88 is held captive between the end of screw 87 and an adjacent portion of forward plate 59. The spring 88 provides bias forces tending to maintain the sub-frame rotated toward a forward position. However, these bias forces are overcome when the compressive forces developed by the helical screw assembly are sufficient.

When forward plate 59 approaches the end of sensor 83, a signal is sent to control computer 44. Control computer 44, in turn, actuates conveyor motor 74, for a pre-determined period of time. This causes conveyor belts 71 and 72 to advance forwardly, along with article brace plate 77. When the proximity switch no longer detects the presence of the frame, and the computer controller de-activates the motor 74. This temporary movement of brace plate 77 is sufficient temporarily to relieve the compressive pressures in the article stack, and to allow the sub-frame rotate forwardly into a start position. However the plate 77 is not advanced so far forwardly that the article stack becomes too loose, or otherwise leans from the vertical. By selective adjustment of the screw 87, the degree of compaction or compression of the stack is determined, so the operator may choose a relatively tight or loose stack of articles.

With continued operation of the apparatus, the compressive pressure in the stack builds again, as more articles are added to the stack. The proximity switch detects the presence of the sub-frame, and the forward drive cycle of the conveyors is repeated. This intermittent drive cycle is repeated until a plurality of articles is assembled on-edge, into stacked, facing relation, to form a horizontal row along the table 76. This condition is shown by the broken line representation of article brace 77, shown in FIG. 7. At this time, the articles are tightly stacked and vertical, ready for immediate transfer to mail trays or other containers.

The operator then removes the stacked row of articles. A spring-biased return assembly 89 is provided to retract the article brace rearwardly, into an initial start position, adjacent the feed end of the conveyor (See, FIG. 1). For that purpose, assembly 89 includes a small retractable cable 91, having an extensible end attached to article brace 77. Owing to the one-way clutch in support wheel 82, the spring-bias forces in assembly 89 are sufficient to roll the brace back, into the start position. A magnetically actuated reed switch 90 is also provided at the end of the article table, to provide fail-safe interruption of the operation of the apparatus, if the operator does not remove the stack in time.

We claim:

1. An apparatus for reorienting and stacking articles, comprising:
a. an article rotation assembly having an input end and an output end, said rotation assembly including a first flat endless belt and a second flat endless belt, said first and second belts being supported at said input end by first and second input rollers and being supported at said output end by first and second output rollers, said first and second rollers having respective axes both parallel with respect to each other and parallel to an article plane, said first roller being above said article plane and said second roller being below said article plane, said rotation assembly further including drive means to counter-rotate said first and second belts, so that at said input end said belts are rotating towards each other, thereby gripping articles and transporting them through said article rotation assembly in a first direction;
b. a helical drive assembly having an entry end and an exit end, said entry end being adjacent said output end of said article rotation assembly to receive articles delivered therefrom, said assembly including a pair of helical screws mounted in parallel relation, said assembly further including means to rotate said screws so as to translate articles on-edge, in parallel, spaced relation, from said entry end to said exit end in a second direction; and,
c. an accumulating conveyor, said conveyor including at least one conveyor belt and an article brace plate transversely positioned thereto, said conveyor having a feed end adjacent said exit end of said helical drive assembly, so that successive articles are delivered from said helical drive assembly to said article brace plate to form a horizontal stack of articles on said accumulating conveyor.

2. An apparatus as in claim 1, including a frame, and in which said helical drive assembly is mounted on a sub-frame which is pivotally mounted said frame.

3. An apparatus as in claim 2, in which said article rotation assembly and said accumulating conveyor are mounted on said frame.

4. An apparatus as in claim 2, in which a lower end of said sub-frame is pivotally mounted to said frame, so that as successive envelopes are stacked on said accumulating conveyor, said sub-frame pivots away from said accumulating conveyor.

5. An apparatus as in claim 4 including sensor means for detecting when said sub-frame has pivoted away a predetermined distance, and for actuating said accumulating conveyor to advance the stacked articles.

6. An apparatus as in claim 1 in which said helical screws are of opposite handedness and are rotated in opposite directions away from each other.

7. An apparatus as in claim 2 in which said article brace plate is slidably mounted on said frame, and in which a retractive bias force is applied rearwardly to said brace plate, in the direction of said helical drive assembly.

8. An apparatus as in claim 7 in which one end of said article brace plate is journaled over a horizontal support rod extending parallel to said conveyor belt, and in which the other end of said article brace plate includes a support wheel resting on said conveyor belt.

9. An apparatus as in claim 8 in which said conveyor belt moves forwardly intermittently, away from said helical drive assembly, and in which said support wheel includes a one-way clutch mechanism which prevents said support wheel to roll forwardly on said conveyor belt, but which allows said support wheel to roll rearwardly on said conveyor belt.

10. An apparatus for reorienting and stacking articles, comprising:
a. article rotating means to reorient the articles from a horizontal orientation to a vertical orientation, said rotating means further including means to move the articles in a first direction from an input end to an output end;
b. helical drive means, for translating the envelopes in parallel spaced relation in a second direction, from an entry end and an exit end, said entry end being adjacent said output end of said article rotation assembly to receive articles delivered therefrom; and,
c. accumulating conveyor means, having a feed end adjacent said exit end of said helical drive means, so that successive articles are delivered from said helical drive assembly to form a horizontal stack of articles on said accumulating conveyor.

11. An article rotation assembly, having an input end and an output end, comprising:
a. a first flat endless belt and a second flat endless belt, said first and second belts being supported at said input end by first and second input rollers and being supported at said output end by first and second output rollers, said first and second input rollers having respective axes both parallel with respect to each other and parallel to an article plane, said first roller being above said article plane and said second roller being below said article plane; and,
b. drive means to counter-rotate said first and second belts, so that at said input end, said belts are rotating towards each other.

12. An assembly as in claim 11 in which said first and second output rollers are parallel and vertical.

13. An assembly as in claim 11 in which said first and second belts have input end portions which are spaced apart a distance approximately equal to a thickness of the articles.

14. An assembly as in claim 11 including a converging chute downstream from said output end.

15. An assembly as in claim 11 including an article input sensor at said input end and an article output sensor at said output end.

16. An assembly as in claim 11 in which the article has a face oriented downwardly when it enters the assembly, and in which said first and second belts have changing planar orientations so that when said belts progress in a first direction from said input end to said output end, the article exits from said output end with its face oriented in a second direction.

17. An assembly as in claim 11 in which the article has a face oriented upwardly when it enters the assembly, and in which said first and second belts have changing planar orientations so that when said belts progress in a first direction from said input end to said output end, the article exist from said output end with its face oriented in a second direction.

18. An assembly as in claim 11 including a upstream tensioning roller and downstream tensioning roller, said upstream roller and said downstream roller being in rolling engagement with portions of said first and second belts intermediate said input end and said output end.

19. A helical drive assembly for successively translating individual articles in parallel, spaced relation, comprising:
a. a sub-frame;
b. a pair of helical screws of opposite handedness, said helical screws being mounted on said sub-frame in parallel, vertically stacked relation, said screws having an entry end for incoming articles and an exit end for outgoing articles; and,
c. means to rotate said screws in opposing rotational directions.

20. An apparatus as in claim 19 including a frame and in which a lower end of said sub-frame is pivotally mounted to said frame.

21. An apparatus as in claim 20 including sensor means for detecting when said sub-frame has pivoted on said frame, a predetermined distance.

22. An apparatus as in claim 19 in which said helical screws have inner shafts, and in which said helical screws are spaced so that the distance between said inner shafts is slightly greater than a top edge to a bottom edge dimension of the articles.

23. An apparatus as in claim 19 in which incoming articles enter said entry end in a first direction, perpendicular to said shafts of said helical screws, and in which the articles are thereafter translated in a second direction, parallel to said shafts.

24. A method for reorienting and stacking flat articles, comprising the steps of:
a. flipping individual articles from a horizontal position to a vertical, on-edge position, while transferring them in a first direction from an entry position to a exit position;
b. translating successive articles in spaced, substantially parallel relation, in a second direction, from said exit position into facing abutment with a trailing article, forming a stack of articles arranged with two of their opposing edges in vertical relation;
c. bringing successive articles into facing abutment until a predetermined compressive pressure is attained in said stack;
d. translating said stack along said second direction until said compressive pressure is relieved.
